(19) United States
(12) Patent Application Publication
(10) Pub. No.: US 2026/0027637 A1
(43) Pub. Date: Jan. 29, 2026

(54) SINGLE CYLINDER MULTIWIRE HORIZONTAL WIRE CUTTING MACHINE

(71) Applicant: TOSPO SEIKI CO., LTD., Taichung City (TW)

(72) Inventor: Sheng-Yi WU, Taichung City (TW)

(21) Appl. No.: 18/901,406

(22) Filed: Sep. 30, 2024

(30) Foreign Application Priority Data
Jul. 29, 2024 (TW) 113208064

(51) Int. Cl. B23H 7/02

(52) U.S. Cl. CPC B23H 7/02

(57) ABSTRACT

A single cylinder multiwire horizontal wire cutting machine, having a workstation, the left side of which has a wire cylinder mechanism and a transmission rail device. A wire cylinder is used for winding an electrode wire thereon, and the transmission rail device enables transverse displacement of the wire cylinder mechanism. The right side of the workstation is provided with a guide wheel mechanism, a transverse transmission device, and a longitudinal transmission device. The longitudinal and transverse transmission device enable longitudinal and transverse displacement of a workpiece. After multiple winding of the electrode wire by the guide wheel mechanism, an outgoing electrode wire and a return electrode wire are separately assigned for cutting a workpiece. The outgoing electrode wire is used to produce free ion cooling water, to carry away foreign substances in the water in a narrow cut area, thereby enabling more precise cutting of a workpiece.

### BACKGROUND OF THE INVENTION

### Field of the Invention

The present invention relates to a single cylinder multiwire horizontal wire cutting machine, and more specifically to a single cylinder multiwire horizontal wire cutting machine, whereby after multiple winding of an electrode wire by a guide wheel mechanism, two or more electrode wires are separately assigned for electric discharge etching of a workpiece. An outgoing electrode wire is used to produce free ion cooling water, to carry away foreign substances in the water in a narrow cut area, thereby preventing the foreign substances from affecting cutting, thus enabling more precise cutting of a workpiece and quicker cutting of large workpieces.

### Description of the Prior Art

According to the prior art, workstations for processing operations and wire cutting machines pertain to the scope of special processing technology, and are a type of machine tool for electrodischarge machining, which is widely used in the processing of superhard materials, difficult-to-machine materials, and thin-walled components. Such machine tools mainly use electrode wires to process a workpiece, wherein a metal workpiece is mounted on a platform surface, and then the electrode wires are drawn close to the metal workpiece to carry out discharge etching thereof. The machine tool mainly uses an electrode wire pulled from a wire cylinder, the electrode wire is then guided and the metal workpiece moved to carry out discharge etching thereof, enabling wire cutting for various types of processing operations. The main mechanism involves a wire cylinder that enables winding the electrode wire therearound, and uses a roller wheel to guide the electrode wire to the workpiece for discharge etch cutting thereof. The electrode wire is used to vertically cut the workpiece, and after cutting, the electrode wire is immediately guided back to the wire cylinder for rewinding thereon. Thus, only a single electrode wire passes over the workpiece, to carry out further discharge etching, a portion of the workpiece requires occasional spraying or immersing in cooling water. The cooling water functions to lower the temperature, insulate, and to remove chips, facilitating trouble-free shaping and processing of the metal workpiece. During the discharge etching process of the metal workpiece, foreign substance flow into the cooling water, at which time, the foreign substances hinder cutting accuracy, easily resulting in cutting errors. Currently, the industry has cooling water filtration mechanisms, which use a filter vat and anion-cation ion exchange resin to alter cooling water quality, and is the method how vertical wire cutting machines improve water quality. However, for transverse cutting machines, the cooling water is poured from two sides of the workpiece (different from vertical wire cutting machines, which pour the cooling water from above the workpiece, whereby the downward flow of water easily carries away foreign substances to below the workpiece). In transverse cutting machines, foreign substances in the cooling water easily remain in cut areas of the workpiece, freely collecting in those areas, affecting the accuracy and quality of the electrode wire discharge etch cutting.

In current transverse wire cutting machines, some companies have replaced the single wire cylinder with two transverse wire cylinders, a single electrode wire from the two wire cylinders being operated to cut a workpiece. However, a two wire cylinder mechanism requires synchronized operation thereof, whereby the two wire cylinders must operate simultaneously to guide the coming in and going out of the electrode wire, which is made from copper that has good ductility. The left and right wire cylinders rotate in the same forward direction to draw out the electrode wire, when the left wire cylinder has completely drawn out the electrode wire, the two wire cylinders then rotate in the same reverse direction, until the right electrode wire is completely drawn out, the action is then repeated. Hence, the instantaneous activation of forward and reverse rotation easily causes stretch elongation of the electrode wire, and thus occasional adjusting the speed ratio of the two wire cylinders is required. Furthermore, temperature increase during the discharge etching process will also cause stretch elongation of the electrode wire, and factors such as obstruction caused by foreign substance production in the cooling water easily results in asynchronous cutting of the workpiece by the one electrode wire from two wire cylinders, producing too many defects in the cut workpiece. These are the main shortcomings of the two wire cylinders single-wire wire cutting machine. As a result, such transverse wire cutting machines cannot be officially launched on the market.

### SUMMARY OF THE INVENTION

The present invention provides a single cylinder multiwire horizontal wire cutting machine, which includes a workstation, which is a case body, with has a platform surface thereon, and the case body is divided into a left bench and a right bench. The left bench comprises a wire cylinder mechanism and a transmission rail device. A wire cylinder is used for winding electrode wire thereon, and the transmission rail device enables transverse displacement of the wire cylinder mechanism. The right bench comprises a guide wheel mechanism, a transverse transmission device, and a longitudinal transmission device. The transverse transmission device and the longitudinal transmission device are respectively stacked and positioned on the platform surface. The longitudinal transmission device drives the transverse transmission device to move longitudinally, and the transverse transmission device drives a frame on the upper side thereof to move transversely.

The present invention is characterized in that:the lower left side of the guide wheel mechanism is configured with a first upright rotating member, a second upright rotating member, a first horizontal guide wheel, and a second horizontal guide wheel; and the right lower side is configured with a third horizontal guide wheel and a fourth horizontal guide wheel.

Accordingly, an outgoing electrode wire is separated from the upper side of the wire cylinder to the upper side of the first upright rotating member and then to the lower side of the second upright rotating member; the outgoing electrode wire is then rewound to the rear side of the first horizontal guide wheel and further rewound to the front side of the second horizontal guide wheel; the outgoing electrode wire then passes the front side of the third horizontal guide wheel, further winds round the rear side of the fourth horizontal guide wheel, and finally winds out from the front of the fourth horizontal guide wheel. A return electrode wire is separated from below the first upright rotating member and returns to the lower side of the wire cylinder. The outgoing electrode wire and the return electrode wire are used for discharge etching a workpiece.

The main object of the present invention lies in using a single transverse wire cylinder, and the electrode wire pulled from therefrom is separated into two wires by the guide wheel mechanism, one is the outgoing electrode wire and the other is the return electrode wire. The outgoing electrode wire and the return electrode wire are used for discharge etching a workpiece. The outgoing electrode wire rapidly agitates cooling water, removing foreign substances produced in cut narrow areas of the workpiece, preventing foreign substances from collecting therein and maintaining cleanness thereof, thus minimizing the accumulation of foreign substances.

A second object of the present invention lies in providing higher processing accuracy and increasing the cutting and processing success rate of workpieces, with application for upright workpieces and transverse wire cutting machines.

Another object of the present invention lies in enabling the cutting of larger workpieces by adjusting the guide wheel mechanism to a lower position, thereby lowering the position of the outgoing electrode wire by a short distance. The return electrode wire is used for a first cutting of an upright workpiece, whereupon the outgoing electrode wire (on a different surface from the return electrode) performs a second cutting of the upright workpiece, staggered from the first cutting area. The discharge gap can be enlarged, enabling easy discharge of foreign substances, thereby enabling even faster cutting of large upright workpieces. Moreover, the outgoing electrode wire easily discharges residual foreign substances, enabling higher cutting precision.

To enable a further understanding of said objectives, structures, characteristics, and effects, as well as the technology and methods used in the present invention and effects achieved, a brief description of the drawings is provided below followed by a detailed description of the preferred embodiments.

### BRIEF DESCRIPTION OF THE DRAWINGS

FIG. 1 is an exploded three-dimensional schematic view of a workstation, a wire cylinder mechanism, and a transmission rail device of the present invention.

FIG. 2 is an exploded three-dimensional schematic view of a guide wheel mechanism of the present invention.

FIG. 3 is an exploded three-dimensional schematic view of a transverse transmission device of the present invention.

FIG. 4 is an exploded three-dimensional schematic view of a longitudinal transmission device of the present invention.

FIG. 5 is an assembled three-dimensional schematic view of the present invention.

FIG. 6 is an assembled three-dimensional schematic view of the guide wheel mechanism of the present invention.

FIG. 6A is an enlarged three-dimensional schematic view of the region marked A in FIG. 6 of the present invention.

FIG. 7 is a cross-sectional schematic view of an outgoing electrode wire and a return electrode wire immersed in cooling water.

FIG. 8 is a front planar schematic view of the present invention.

FIG. 9 is an overhead planar schematic view of the present invention.

FIG. 10 is a right planar schematic view of the present invention.

FIG. 11 is a planar schematic view of a first horizontal guide wheel, a second horizontal guide wheel, a third horizontal guide wheel, and a fourth horizontal guide wheel with the bottom portions level according to the present invention.

FIG. 12 is a cross-sectional schematic view of the consecutive action of the return electrode wire and the outgoing electrode wire cutting a slightly smaller workpiece according to the present invention.

FIG. 13 is a planar schematic view of the second horizontal guide wheel and the third horizontal guide wheel lowered according to the present invention.

FIG. 14 is a cross-sectional schematic view of the consecutive action of the return electrode wire and the outgoing electrode wire cutting a slightly larger workpiece according to the present invention.

### DETAILED DESCRIPTION OF THE PREFERRED EMBODIMENTS

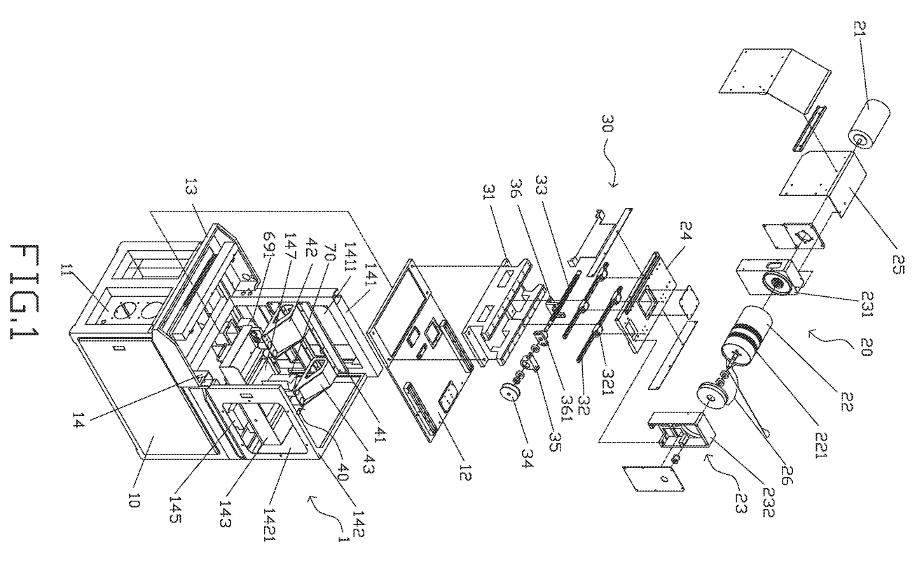

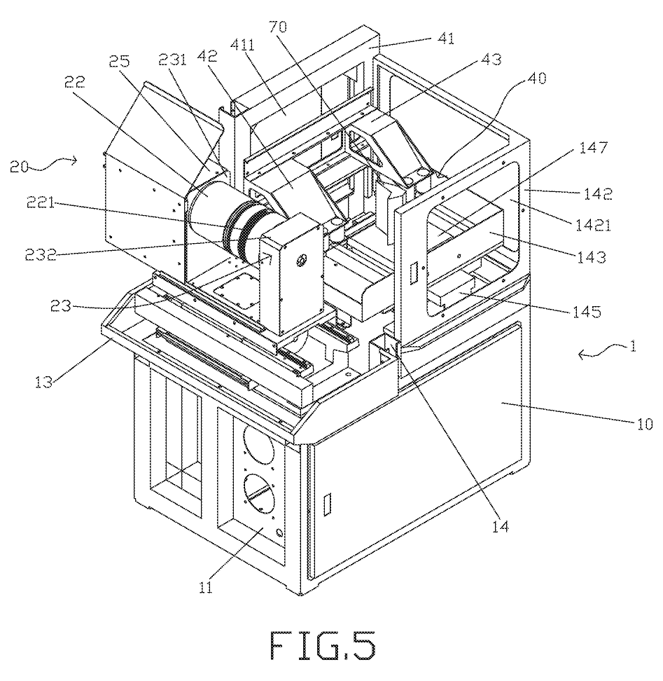

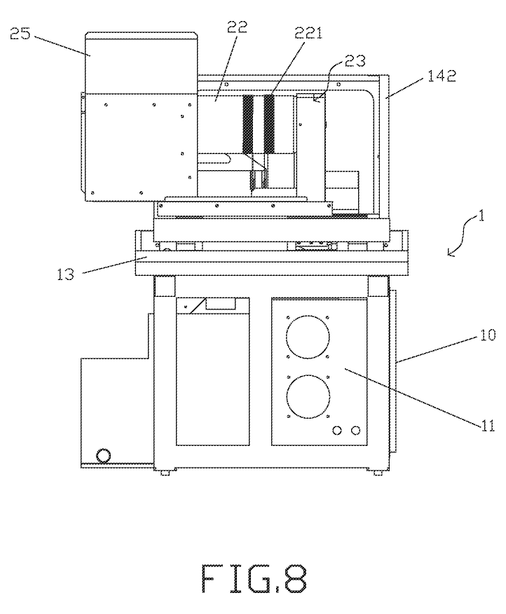

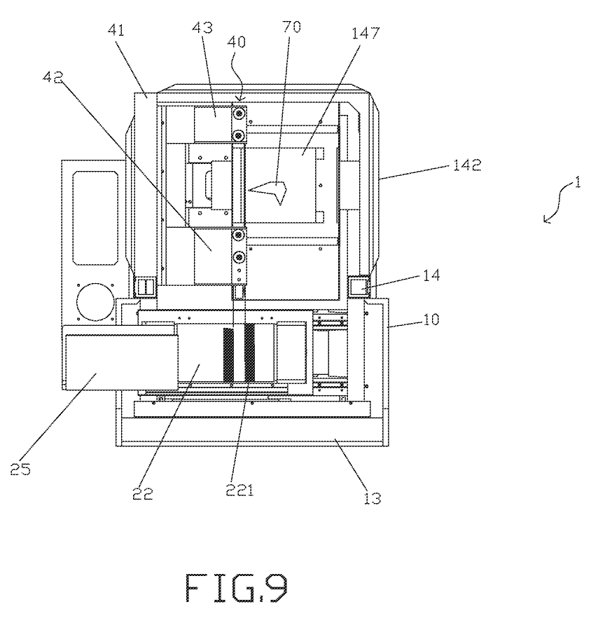

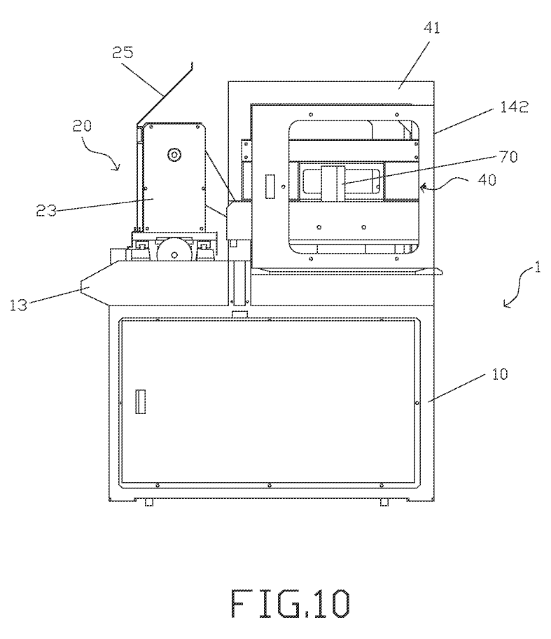

Referring to FIGS. 1 and 5, and FIGS. 8 to 10, which show a workstation 1 of the present invention used for wire cutting, wherein wire cutting of the present invention pertains to medium and fast wire cutting. The workstation 1 includes a case body 10, the lower portion of which has electrical equipment 11 (that pertains to general skills and known principles, wherein the electrical equipment 11 controls supply of voltage to an electrode wire 221, which is used for discharge etching of an upright workpiece 70). A platform surface 12 is assembled on the case body 10, and the case body 10 is divided into a left bench 13 and a right bench 14. The left bench 13 comprises a wire cylinder mechanism 20 and a transmission rail device 30, wherein the wire cylinder mechanism 20 is fitted with a motor 21, a wire cylinder 22, a wire cylinder frame 23, and a wire cylinder frame platform 24. The wire cylinder frame platform 24 enables mounting the wire cylinder frame 23 thereon, and the wire cylinder 22 is assembled on the wire cylinder frame 23. The motor 22 enables the wire cylinder 22 to rotate, thereby enabling winding the electrode wire 221 thereon. The wire cylinder frame 23 has a front wire cylinder frame 231 and a rear wire cylinder frame 232. The motor 21 and a plurality of protective plates 25 are mounted on the front side of the front wire cylinder frame 231, and the front side of the rear wire cylinder frame 232 is provided with a bearing device 26. The transmission rail device 30 is mounted on the left side of the platform surface 12, thereby providing traverse movement of the wire cylinder frame 23. The transmission rail device 30 comprises a dual rail base 31, two rails 32, a drive screw 33, a first servomotor 34, a passive upper pivot base 35, and a lower pivot base 36, wherein the dual rail base 31 is joined to the platform surface 12. The two rails 32 are respectively fixedly positioned on the left and right upper sides of the dual rail base 31; each of the rails 32 has two sliding blocks 321 thereon, and the sliding blocks 321 are joined to the bottom surface of the wire cylinder frame platform 24. The first servomotor 34 rotates the drive screw 33. The lower pivot base 36 is joined to the center of the dual rail base 31, wherein the lower pivot base 36 is further joined to a middle member 361 and the first servomotor 34. The passive upper pivot base 35 is joined to the wire cylinder frame platform 24, and the passive upper pivot base 35 is provided with an internal threaded hole, enabling driving and displacement thereof by the drive screw 33, thereby concurrently connectively displacing the wire cylinder frame platform 24.

Referring to FIGS. 1 to 4, which show the right bench 14 comprising a window frame 141, a door panel 142, a guide wheel mechanism 40, a water holding cover 143, a panel surface 144, a frame 145, a hollow internal surface 146, a transverse transmission device 50, and a longitudinal transmission device 60. The window frame 141 is fixed to the case body 10, and a rear glass window 1411 is fitted inside the window frame 141. The door panel 142 is L-shaped, one side of which is pivot connected to the outer edge of the window frame 141, and a front glass window 1421 is fitted inside the door panel 142. The guide wheel mechanism 40 is provided with a cantilever frame 41, which is mounted on the window frame 141. The water holding cover 143 stores cooling water, as well as enabling mounting a machine panel 147 therein. The upright workpiece 70 is fixedly positioned on the machine panel 147 (there is a clamping and positioning mechanism on the upper side of the workpiece 70, which belongs to known technology, and is not shown in the drawings). Some operators directly form the machine panel 147 and the workpiece 70 as an integral body, separating them by wire cutting. A portion of the workpiece 70 is immersed in the cooling water, and the panel surface 144 and the frame 145 are sequentially positioned below the water holding cover 143. The hollow internal surface 146 is fixedly positioned inside the frame 145.

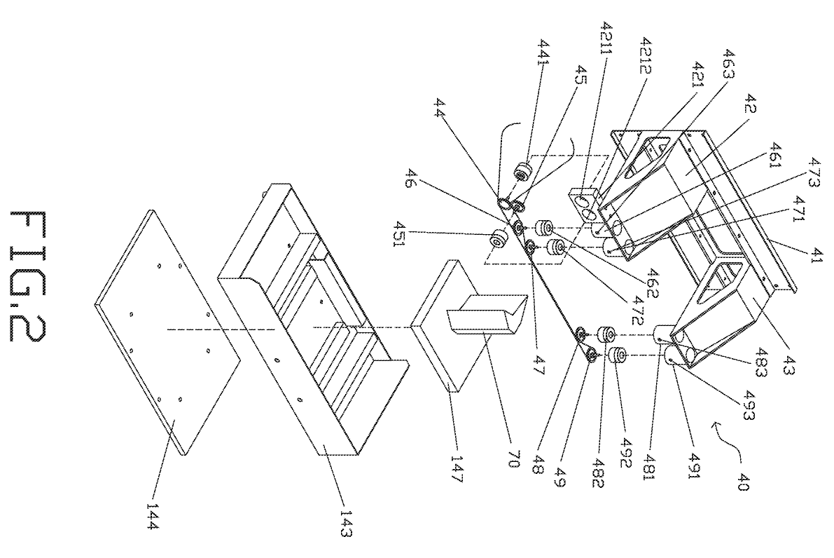

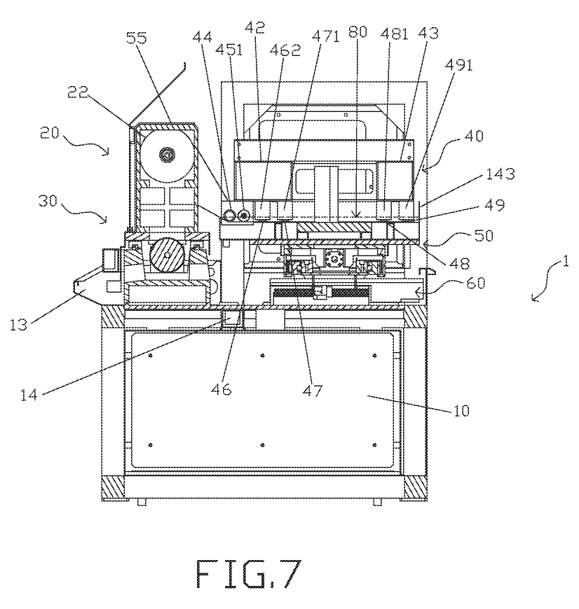

Referring to FIGS. 2, 6, and 7, which show a left cantilever 42 and a right cantilever 43 extending frontward from the cantilever frame 41 of the guide wheel mechanism 40. A first upright rotating member 44, a second upright rotating member 45, a first horizontal guide wheel 46, and a second horizontal guide wheel 47 are configured on the lower side of the end portion of the left cantilever 42. A third horizontal guide wheel 48 and a fourth horizontal guide wheel 49 are configured on the lower side of the end portion of the right cantilever 43. A suspended block 421, a first horizontal bearing 441, a second horizontal bearing 451, a first upright pivot cylinder 461, and a second upright pivot cylinder 471 are configured on the lower side of the end portion of the left cantilever 42. A third upright pivot cylinder 481 and a fourth upright pivot cylinder 491 are configured on the lower side of the end portion of the right cantilever 43. The suspended block 421 is provided with a first round hole 4211 and a second round hole 4212, wherein the first horizontal bearing 441 is pivotally connected inside the first round hole 4211. An end portion of the first horizontal bearing 441 enables connecting the first upright rotating member 44 thereto. The second horizontal bearing 451 is pivotally connected inside the second round hole 4212, and an end portion of the second horizontal bearing 451 enables connecting the second upright rotating member 45 thereto. The first upright pivot cylinder 461 enables pivot connecting a first upright bearing 462 thereto, wherein the first horizontal guide wheel 46 is connected to the bottom portion of the first upright bearing 462. The second upright pivot cylinder 471 enables pivot connecting a second upright bearing 472 thereto,wherein the second horizontal guide wheel 47 is connected to the bottom portion of the second upright bearing 472. The third upright pivot cylinder 481 enables pivot connecting a third upright bearing 482 thereto, wherein the third horizontal guide wheel 48 is connected to the bottom portion of the third upright bearing 482. The fourth upright pivot cylinder 491 enables pivot connecting a fourth upright bearing 492 thereto, wherein the fourth horizontal guide wheel 49 is connected to the bottom portion of the fourth upright bearing 492. The outgoing electrode wire 221 is separated from the upper side of the wire cylinder 22 to the upper side of the first upright rotating member 44, then to the lower side of the second upright rotating member 45, then rewound to the rear side of the first horizontal guide wheel 46, and further rewound to the front side of the second horizontal guide wheel 47. An outgoing electrode wire 221a (of the outgoing electrode wire 221), which is used for discharge etching a workpiece, passes the front side of the third horizontal guide wheel 48, then winds round the rear side of the fourth horizontal guide wheel 49, and winds out from the front of the fourth horizontal guide wheel 49. A return electrode wire 221b (of the outgoing electrode wire 221) is separated from and directly pulled to below the first upright rotating member 44 and returns to the blower side of the wire cylinder 22. The return electrode wire 221b is also used for discharge etching a workpiece. The outgoing electrode wire 221a pulled from the wire cylinder 22 and the return electrode wire 221b are both immersed below a horizontal surface 80 of the cooling water in the water holding cover 143; neither the outgoing electrode wire 221a nor the return electrode wire 221b float above the water surface 80 (see FIG. 7).

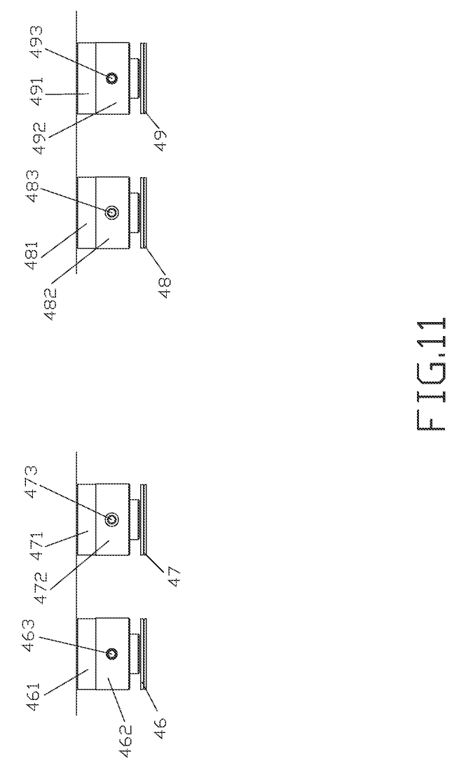

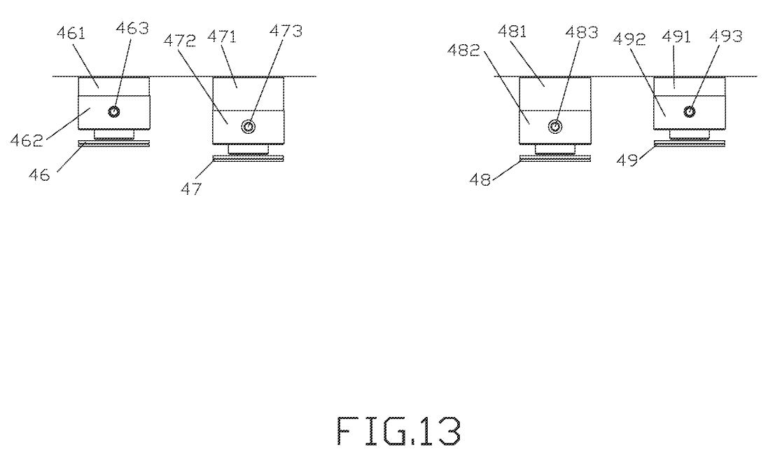

Referring to FIGS. 11 and 13, the wall surface of the first upright pivot cylinder 461 of the guide wheel mechanism 40 is fitted with two first butt studs 463 (inner quadrangular studs or inner hexagonal studs are used), which are used to butt against the outer casing of the first upright bearing 462, thereby enabling positioning the first upright bearing 462 within the first upright pivot cylinder 461, whilst also enabling adjustment of the high and low position of the first upright bearing 462 (including the first horizontal guide wheel 46). Similarly, the second upright pivot cylinder 471 is fitted with two second butt studs 473, the third upright pivot cylinder 481 is fitted with two third butt studs 483, and the fourth upright pivot cylinder 491 is fitted with two fourth butt studs 493.

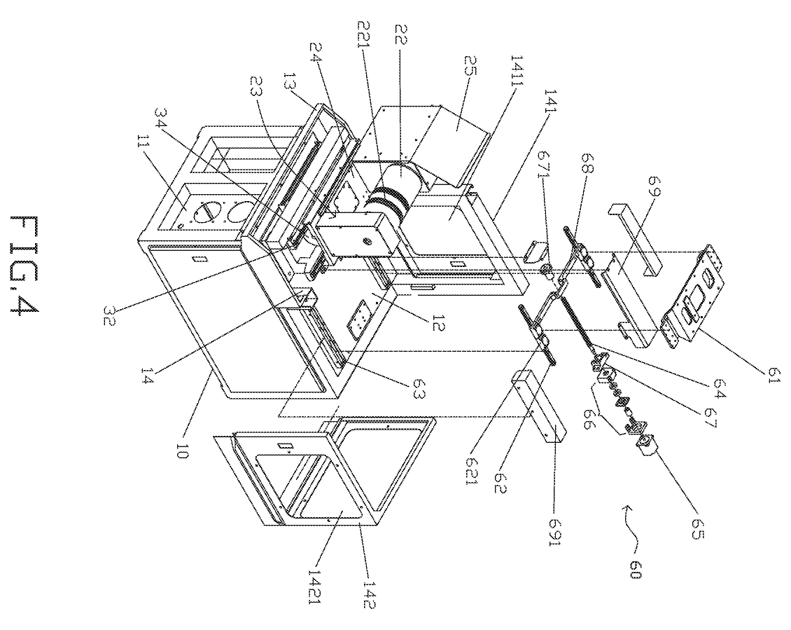

Referring to FIG. 4, the longitudinal transmission device 60 comprises a transverse platform surface 61, two longitudinal rails 62, two longitudinal rail grooves 63, a longitudinal screw 64, a second servomotor 65, a longitudinal pivot base 66, a longitudinal passive block 67, and a bracket 68. The two longitudinal rail grooves 63 are fixedly positioned to the platform surface 12, and each of the longitudinal rails 62 is joined to the respective longitudinal rail groove 63. A longitudinal dual sliding block 621 is provided on each of the longitudinal rails 62, and the inner side of each of the longitudinal dual sliding blocks 621 is joined to the respective side end of the bracket 68. The top surfaces of the longitudinal dual sliding blocks 621 are joined to the transverse platform surface 61. The longitudinal pivot base 66 is configured with the second servomotor 65 and the longitudinal screw 64, which drives the longitudinal passive block 67 and the bracket 68. The longitudinal passive block 67 is joined to a longitudinal cap 671, which is provided with an internal screw hole that enables the longitudinal screw 64 to penetrate therethrough. The longitudinal passive block 67 connectively drives the transverse platform surface 61 to enable longitudinal displacement thereof. A longitudinal center guard 69 is fitted above the longitudinal screw 64, and each outer side of the longitudinal rails 62 is mounted with a longitudinal side cover 691. The longitudinal center guard 69 and the longitudinal side covers 691 protect the longitudinal screw 64 and the longitudinal rails 62 from being impacted by cooling water.

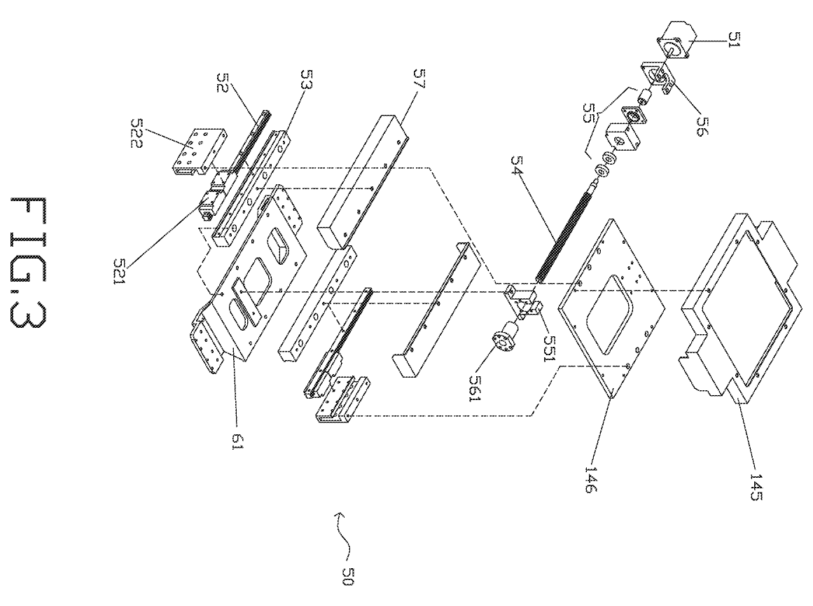

Referring to FIG. 3, which shows the transverse transmission device 50 provided with a third servomotor 51, two transverse rails 52, two transverse rail grooves 53, a transverse screw 54, a bearing assembly 55, a front pivot base 551, and a rear pivot base 56. The front pivot base 551, the bearing assembly 55, and the rear pivot base 56 are configured to the third servomotor 51 and the transverse screw 54. The rear pivot base 56 is positioned and joined to the lower side of the hollow internal surface 146. The front pivot base 551 is positioned and joined to the top surface of the transverse platform surface 61, and each of the transverse rail grooves 53 are open to the two outer side directions. The transverse rails 52 are respectively positioned in the transverse rail grooves 53, and each of the transverse rails 52 enable displacement of a transverse dual sliding block 521 thereon, each of which is joined to a side bearer 522. The upper side of each of the two side bearers 522 is further joined to the hollow internal surface 146. The outer side of each of the transverse rails 52 is fitted with a transverse side cover 57, each of which is fixedly positioned on the upper side of the respective transverse rail groove 53, wherein the transverse side covers 57 protect the transverse rails 52 from being impacted by the cooling water. In addition, the frame 145 is joined to the panel surface 144 (see FIG. 2), and the hollow internal surface 146 is internally joined to the frame 145. The front pivot base 551 is joined to a transverse cap 561, which is provided with an internal screw hole that enables the transverse screw 54 to penetrate therethrough. The transverse screw 54 uses the front pivot base 551 as a base for interaction, to connectively drive transverse displacement of the hollow internal surface 146 and the frame 145, whereupon the frame 145 connectively drives the panel surface 144. The transverse transmission device 50 and the longitudinal transmission device 60 (see FIG. 4) are respectively stacked and positioned on the platform surface 12, wherein the transverse transmission device 50 is positioned below the hollow internal surface 146. The longitudinal transmission device 60 drives the transverse transmission device 50 to move longitudinally; the transverse transmission device 50 drives devices the frame 145 on the upper side thereof to move transversely.

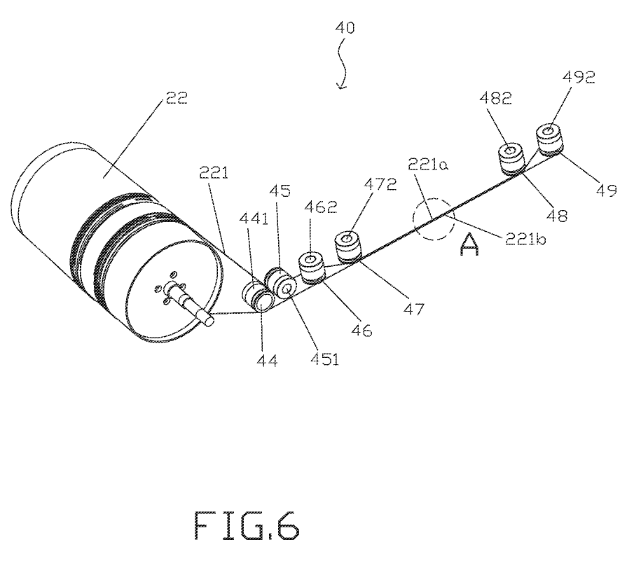

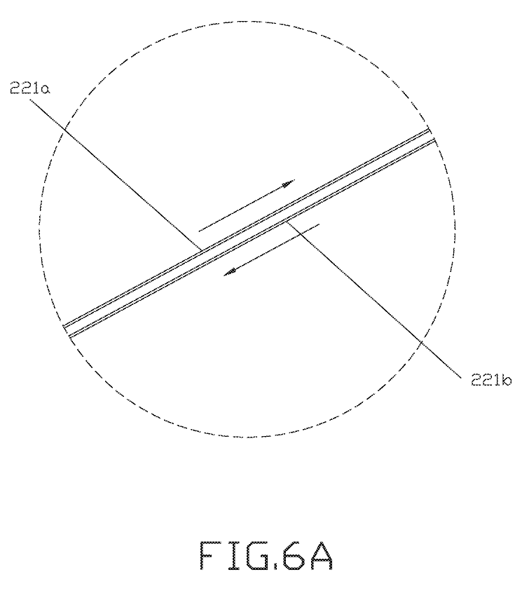

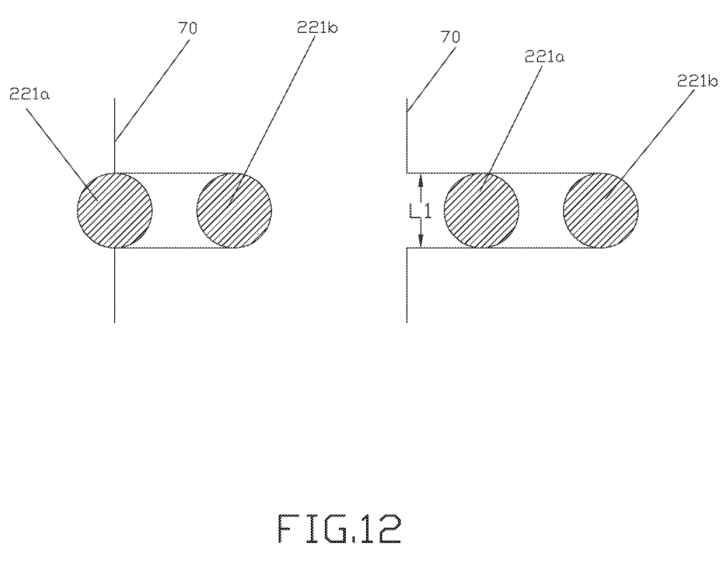

According to the above-described improved structure, after the workpiece 70 is set up on the workstation 1 of the present invention, the longitudinal transmission device 60 enables driving longitudinal displacement of the workpiece 70 (the workstation 1 of the present invention is directed towards upright placement of a workpiece) and the transverse transmission device 50 enables driving transverse displacement of the workpiece 70. The transmission rail device 30 enables transverse displacement of the wire cylinder mechanism 20. Referring to FIGS. 6, 6A, and 7, the present invention mainly uses the guide wheel mechanism 40 to separate the electrode wire 221 pulled from the transverse wire cylinder 22 into two wires, whereby one wire is the outgoing electrode wire 221a and the other wire is the return electrode wire 221b, wherein the outgoing electrode wire 221a and the return electrode wire 221b are both used for discharge etching the workpiece 70. When the bottom portions of the first horizontal guide wheel 46, the second horizontal guide wheel 47, the third horizontal guide wheel 48, and the fourth horizontal guide wheel 49 are flush with each other (see FIG. 11), the workpiece 70 is displaced to the return electrode wire 221b, and a narrow area L1 of the workpiece 70 can be cut, as shown in FIG. 12; this being used for the slightly smaller upright workpiece 70. Because a portion of the workpiece 70, the outgoing electrode wire 221a and the return electrode wire 221b are immersed in cooling water of the water holding cover 143, the outgoing electrode wire 221a rapidly agitates the cooling water, thereby quickly removing residual foreign substances produced in the cut narrow area L1, enabling the front and rear of the cut narrow area L1 to be kept clean, and thus preventing foreign substances from collecting therein, thereby minimizing foreign substances and enabling precise cutting of metal.

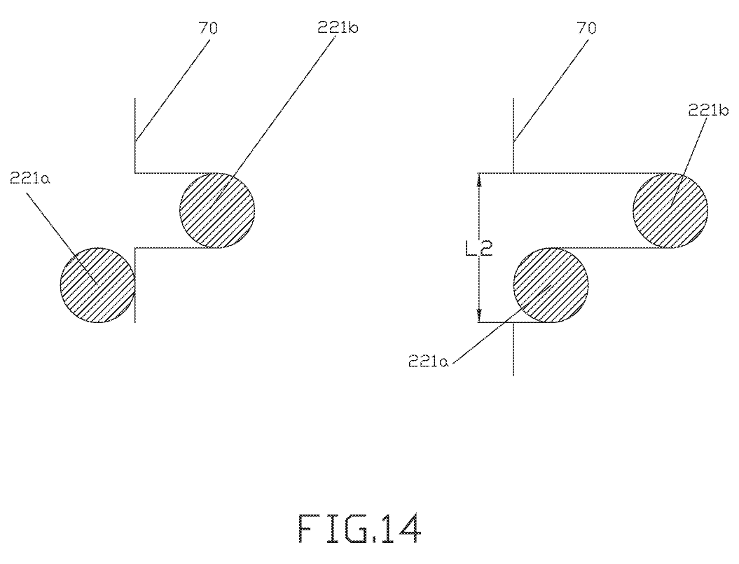

Referring to FIGS. 13 and 14, to cut the larger workpiece 70, the second upright bearing 472 (including the second horizontal guide wheel 47) and the third upright bearing 482 (including the third horizontal guide wheel 48) are adjusted to lower positions, without lowering the first upright bearing 462 (including the first horizontal guide wheel 46) and the fourth upright bearing 492 (including the fourth horizontal guide wheel 49), their positions remaining unchanged, which enables lowering the position of the outgoing electrode wire 221a by a short distance. When the upright workpiece 70 is displaced to the return electrode wire 221b, the return electrode wire 221b performs the first cutting of the upright workpiece 70, whereupon the outgoing electrode wire 221a (on a different surface area from the return electrode wire 221b) performs the second cutting of the upright workpiece 70 staggered from the first cutting area, thereby enabling even faster cutting of the larger upright workpiece 70; moreover, the outgoing electrode wire 221a easily discharges foreign substances. The outgoing electrode wire 221a rapidly agitates the cooling water, removing foreign substances produced in a cut narrow area L2, enabling the front and rear of the cut narrow area L2 to be kept clean, and thus preventing foreign substances from collecting therein, thereby minimizing foreign substances and enabling faster cutting of metal (the width of L2 > the width of L1, and thus no need to cut twice or move the workpiece back and forth, saving time), allowing for higher cutting precision. The discharge gap can be enlarged, enabling easy discharge of residual foreign substances. Furthermore, the wire cylinder 22 of the present invention is a single cylinder, which distinguishes it from the prior art wherein two wire cylinders are used, pulling a single electrode wire, which results in shortcomings including out of sync operation that easily causes rapid extension of the electrode wire. Additional shortcomings of dual wire cylinders single-wire wire cutting machines of the prior art include activating instantaneous repeated forward and reverse rotation of the dual wire cylinders, producing stretch elongation of the electrode wire, requiring occasional adjustment to the speed ratio of the two wire cylinders. Furthermore, factors including obstruction caused by foreign substance production and temperature increase in the cooling water easily causes asynchronous cutting of the workpiece by the dual wire cylinders single-wire wire cutting machines of the prior art, which results in producing too many defects in the cut workpiece. The present invention is totally different to the above-described two wire cylinder structure of the prior art, and substantially improves upon the shortcomings thereof. There is no synchronization problem in the present invention, and there is also no problem of electrode wire extension caused by the forward and reverse rotation of dual wire cylinders, thereby avoiding the complicated operating procedure of having to frequently adjust the speed ratio of the two wire cylinders.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A single cylinder multiwire transverse wire cutting machine, comprising a workstation, which is a case body, the lower side of which has electrical equipment, a platform surface is assembled on the case body, and the case body is divided into a left bench and a right bench; the left bench comprises:
a wire cylinder mechanism, which is provided with a motor, a wire cylinder, a wire cylinder frame, and a wire cylinder frame platform; the wire cylinder frame platform enables mounting the wire cylinder frame thereon; the wire cylinder is assembled on the wire cylinder frame, and the motor enables the wire cylinder to rotate; the wire cylinder enables winding an electrode wire thereon, and the electrical equipment controls the electrode wire to carry out discharge etching of a workpiece;
a transmission rail device, which is mounted on a left side of the platform surface, thereby providing traverse movement of the wire cylinder frame;
the right bench comprises:
a window frame and a door panel; the window frame is fixed to the case body, and a glass window is fitted inside the window frame; the door panel is L-shaped, one side of which is pivot connected to an outer edge of the window frame, and a front glass window is fitted inside the door panel;
a guide wheel mechanism, which is provided with a cantilever frame, which enables mounting on the window frame;
a water holding cover, a panel surface, a frame, a hollow internal surface, a transverse transmission device, and a longitudinal transmission device; the water holding cover stores cooling water and enables mounting a machine panel therein; a workpiece is positioned on the machine panel, and a portion of the workpiece is immersed in the cooling water; the panel surface and the frame are sequentially positioned below a lower side of the water holding cover; the hollow internal surface is positioned inside the frame, and the transverse transmission device and the longitudinal transmission device are respectively stacked and positioned on the platform surface; the transverse transmission device is positioned on a lower side of the hollow internal surface; the longitudinal transmission device drives the transverse transmission device to move longitudinally; the transverse transmission device drives a frame on the upper side thereof to move transversely,
wherein, a left cantilever and a right cantilever extend frontward from the cantilever frame of the guide wheel mechanism; a first upright rotating member, a second upright rotating member, a first horizontal guide wheel, and a second horizontal guide wheel are configured below an end portion of the left cantilever; a third horizontal guide wheel and a fourth horizontal guide wheel are configured below an end portion of the right cantilever;
accordingly, an outgoing electrode wire is pulled from an upper side of the wire cylinder to an upper side of the first upright rotating member and then to a lower side of the second upright rotating member, the outgoing electrode wire is then rewound to a rear side of the first horizontal guide wheel and further rewound to a front side of the second horizontal guide wheel, the outgoing electrode wire then passes a front side of the third horizontal guide wheel and winds round a rear side of the fourth horizontal guide wheel to wind out from a front of the fourth horizontal guide wheel; a return electrode wire is pulled from the wire cylinder to below the first upright rotating member and returns to a lower side of the wire cylinder; the outgoing electrode wire and the return electrode wire are used for discharge etching a workpiece.

2. The single cylinder multiwire transverse wire cutting machine according to claim 1, wherein a suspended block, a first horizontal bearing, a second horizontal bearing, a first upright pivot cylinder, and a second upright pivot cylinder are configured below the end portion of the left cantilever; a third upright pivot cylinder and a fourth upright pivot cylinder are configured below the end portion of the right cantilever; the suspended block is provided with a first round hole and a second round hole, and the first horizontal bearing is pivotally connected inside the first round hole; an end portion of the first horizontal bearing enables connecting the first upright rotating member thereto, and the second horizontal bearing is pivotally connected inside the second round hole; an end portion of the second horizontal bearing enables connecting the second upright rotating member thereto, and the first upright pivot cylinder enables pivot connecting a first upright bearing thereto; the first horizontal guide wheel is connected to a bottom portion of the first upright bearing, and a second upright pivot cylinder enables pivot connecting the second upright bearing thereto; the second horizontal guide wheel is connected to a bottom portion of the second upright bearing, and the third upright pivot cylinder enables pivot connecting a third upright bearing thereto; the third horizontal guide wheel is connected to a bottom portion of the third upright bearing, and the fourth upright pivot cylinder enables pivot connecting a fourth upright bearing thereto; the fourth horizontal guide wheel is connected to a bottom portion of the fourth upright bearing.

3. The single cylinder multiwire transverse wire cutting machine according to claim 2, wherein a wall surface of the first upright pivot cylinder is configured with two first butt studs, which are used to butt against and fixedly position the first upright bearing; the second upright pivot cylinder is configured with two second butt studs, which are used to butt against and fixedly position the second upright bearing; the third upright pivot cylinder is configured with two third butt studs, which are used to butt against and fixedly position the third upright bearing; and the fourth upright pivot cylinder is configured with two fourth butt studs, which are used to butt against and fixedly position the fourth upright bearing.

4. The single cylinder multiwire transverse wire cutting machine according to claim 1, wherein the wire cylinder frame has a front wire cylinder frame and a rear wire cylinder frame; a motor and a plurality of protective plates are mounted on a front side of the front wire cylinder frame, and a front side of the rear wire cylinder frame is provided with a bearing device.

5. The single cylinder multiwire transverse wire cutting machine according to claim 1, wherein the transmission rail device comprises a dual rail base, two rails, a drive screw, a first servomotor, a passive upper pivot base, and a lower pivot base; the dual rail base is joined to the platform surface, and the two rails are respectively fixedly positioned on a left and right upper sides of the dual rail base; each of the rails has two sliding blocks thereon, which are joined to a bottom surface of the wire cylinder frame platform; the first servomotor rotates the drive screw; the lower pivot base is joined to a center of the dual rail base; the lower pivot base is further joined to a middle member and the first servomotor; the passive upper pivot base is joined to the wire cylinder frame platform, enabling driving and displacement thereof by the drive screw, as well as concurrently connectively displacing the wire cylinder frame platform.

6. The single cylinder multiwire transverse wire cutting machine according to claim 1, wherein the longitudinal transmission device comprises a transverse platform surface, two longitudinal rails, two longitudinal rail grooves, a longitudinal screw, a second servomotor, a longitudinal pivot base, a longitudinal passive block, and a bracket, wherein the two longitudinal rail grooves are fixedly positioned to the platform surface, and the longitudinal rails are respectively joined to the longitudinal rail grooves; a longitudinal dual sliding block is provided on each of the longitudinal rails, inner sides of the longitudinal dual sliding block are respectively joined to side ends of the bracket, and top surfaces of the longitudinal dual sliding block are respectively joined to the transverse platform surface; the second servomotor and the longitudinal screw are mounted on the longitudinal pivot base, and the longitudinal screw drives the longitudinal passive block and the bracket; the longitudinal passive block is joined to a longitudinal cap, which is provided with an internal screw hole that enables the longitudinal screw to penetrate therethrough; the longitudinal passive block connectively drives the transverse platform surface to enable longitudinal displacement thereof; a longitudinal center guard is fitted on the longitudinal screw, and each outer side of the longitudinal rail is fitted with a longitudinal side cover; the transverse transmission device is provided with a third servomotor, two transverse rails, two transverse rail grooves, a transverse screw, a bearing assembly, a front pivot base, and a rear pivot base, wherein the front pivot base, the bearing assembly, and the rear pivot base are configured to the third servomotor and the transverse screw; the rear pivot base is positioned and joined to the lower side of the hollow internal surface, and the front pivot base is positioned and joined to a top surface of the transverse platform surface; each of the transverse rail grooves are open to the two outer side directions, and the transverse rails are respectively positioned in the transverse rail grooves; each of the transverse rails enable displacement of a transverse dual sliding block thereon, each of the two transverse dual sliding blocks is joined to a side bearer; and an upper side of each of the two side bearers is further joined to the hollow internal surface, an outer side of each of the transverse rails is fitted with a transverse side cover, each of which is fixedly positioned on an upper side of the respective transverse rail groove; the frame is joined to the panel surface, and further internally joined to the hollow internal surface; the front pivot base is joined to a transverse cap, which is provided with an internal screw hole that enables the transverse screw to penetrate therethrough, and the transverse screw uses the front pivot base as a base for interaction, to connectively drive transverse displacement of the hollow internal surface and the frame, whereupon the frame connectively drives the panel surface.

7. The single cylinder multiwire transverse wire cutting machine according to claim 1, wherein the outgoing electrode wire pulled from the wire cylinder and the return electrode wire are both immersed below a horizontal surface of the cooling water in the water holding cover.
